(19) United States
(12) Patent Application Publication
(10) Pub. No.: US 2007/0177215 A1
(43) Pub. Date: Aug. 2, 2007

(54) Text rendering contrast

(75) Inventors: Mikhail M. Lyapunov, Woodinville, WA (US); Christopher J. Han, Seattle, WA (US); David C. Brown, Basingstoke (GB); Jason H. Hartman, Woodinville, WA (US); Michael J. Duggan, Kirkland, WA (US); Mikhail V. Leonov, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/345,016

(22) Filed: Feb. 1, 2006

(51) Int. Cl. G06F 15/00

(52) U.S. Cl. 358/3.12; 358/1.9; 358/3.1

(57) ABSTRACT

Various technologies and techniques are disclosed that improve text rendering contrast. The shape of one or more characters is converted from an original format, such as a vector format received from a font, to an overscaled bitmap format. The width of the shape of the character is adjusted based on a text contrast setting. For example, the width of the shape can be adjusted by extending a right or other edge of the shape by the number of pixels corresponding to the numerical value of the text contrast setting. The shape is made wider or thinner based on the text contrast setting. A filtering procedure is used to determine density values for how the shape corresponds to a set of screen pixels. The density values are blended with color values related to the display device to form a modified shape ready for output. The modified shape is then displayed.

### BACKGROUND

A particular portion of text does not display in the same manner on all display devices due to hardware and software variations. Furthermore, not all users view the same text on a particular display in the same fashion. Various techniques can be used to adjust the appearance of text to make it more legible to the user. For example, the side effect of gamma correction is sometimes used to adjust text rendering contrast. Gamma correction is a software feature meant to take into account the nonlinear dependency of emitted light energy upon numerical color intensity values calculated by rendering software. By forcing gamma correction to mismatch the physical feature of the display, the visible text contrast is often changed.

There are five main problems with using gamma correction to adjust text contrast: First, it can cause color fringes on vertical edges of certain character stems, such as when text is being rendered with MICROSOFT® CLEARTYPE® technology. This is distracting for users who are sensitive to color. Second, in animated text scenarios, visible deviation of stem density is created when text is moving slowly in the horizontal direction. Third, by using gamma correction to adjust text contrast, color invariance cannot be provided. In other words, if the contrast of black-on-white text is increased, the contrast of white-on-black contrast is lost. Fourth, it causes color distortions on both background and foreground colors when they are not black or white, so that the colors differ from desired ones. The final problem with using gamma correction to adjust text contrast is that the overall rendering system consistency is worsened. For example, the components not related to text, such as geometry and bitmap graphics, either require separate gamma correction settings or acceptance of the distortions caused by mismatch between real display features and gamma correction settings changed in favor of text contrast.

### SUMMARY

Various technologies and techniques are disclosed that improve text rendering contrast. The shape of one or more characters is converted from an original format, such as a vector format received from a font, to an overscaled bitmap format. The width of the shape of the character in the overscaled bitmap format is adjusted based on a text contrast setting, such as one that is adjustable by a user. For example, in one implementation, the width of the shape is adjusted by extending a right or other edge of the stems of the shape by the number of pixels corresponding to the numerical value associated with the text contrast setting. In other words, the stems of the shapes are made wider or thinner based on the text contrast setting. A filtering procedure is used to determine density values for how the shape corresponds to a set of screen pixels. The density values for the shape are then blended with color values and/or a gamma correction setting related to the display device to form a modified shape ready for output. As one non-limiting example, color values can include background and/or foreground color settings. The modified shape is then displayed on the display device.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a text rendering application of one implementation operating on the computer system of FIG. 1.

FIG. 3 is a high-level process flow diagram for one implementation of the system of FIG. 1.

FIG. 4 is a flow diagram for one implementation of the system of FIG. 1 illustrating the stages involved in improving text rendering contrast.

FIG. 5 is a process flow diagram for one implementation of the system of FIG. 1 illustrating the stages involved in adjusting text rendering contrast based on a text contrast setting.

FIG. 6 is a simulated screen for one implementation of the system of FIG. 1 that illustrates allowing a user to specify a text contrast setting in a user interface.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that improves text rendering contrast, but the system also serves other purposes in addition to these. In one implementation, one or more of the techniques described herein can be implemented as features within a presentation sub-system of an operating system such as MICROSOFT® WINDOWS® or Linux, or from any other type of program or service that is responsible for rendering text.

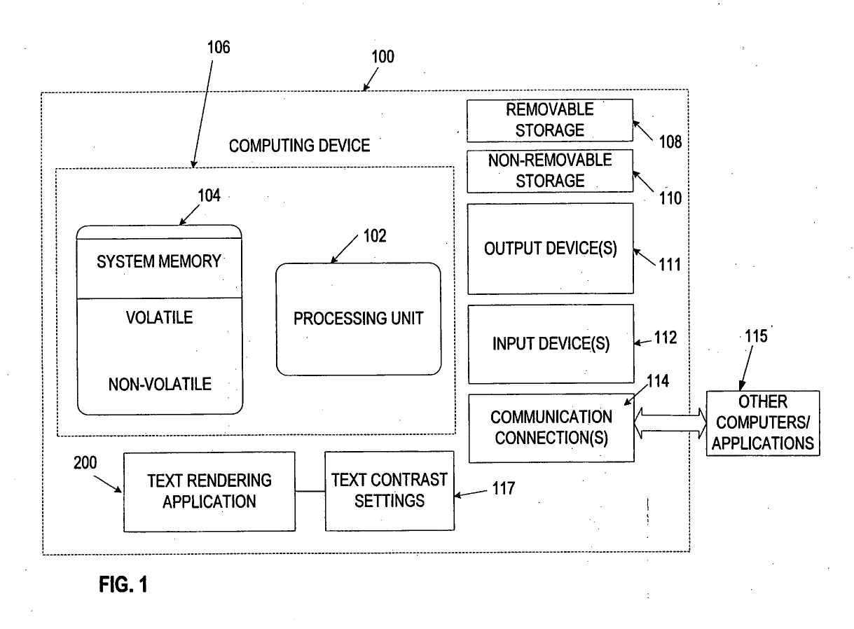

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here.

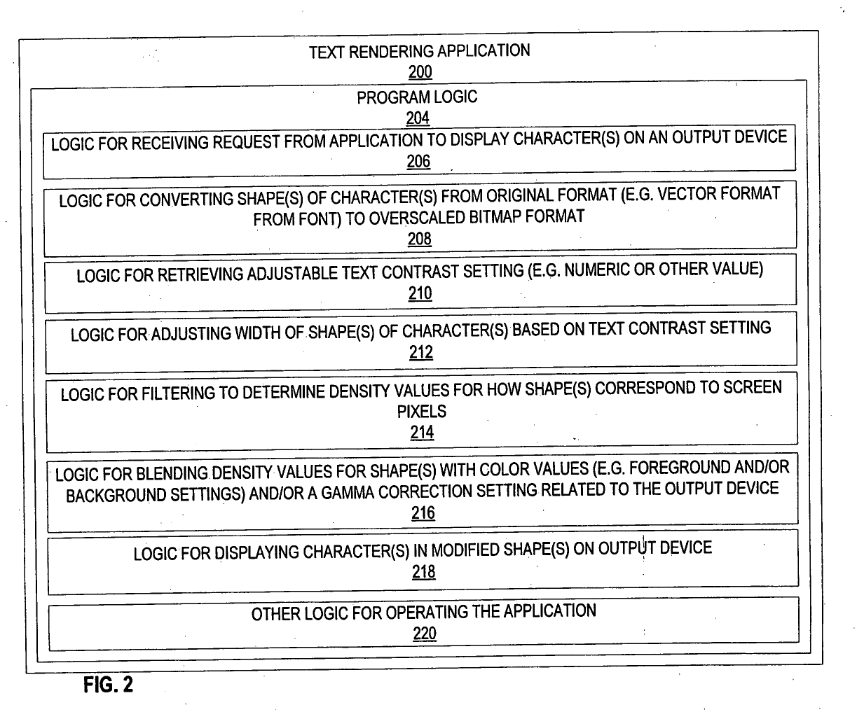

Computing device 100 includes text rendering application 200, which is responsible for preparing text for display on an output device 111. Text rendering application 200 is operable to retrieve text contrast setting(s) 117, such as those specified by a user in a user interface. Text rendering application 200 is described in further detail in the figures that follow. Turning now to FIG. 2 with continued reference to FIG. 1, text rendering application 200 operating on computing device 100 is further illustrated. Text rendering application 200 is one of the application programs that reside on computing device 100. Alternatively or additionally, one or more parts of text rendering application 200 can be part of system memory 104, on other computers and/or applications 115, or other such variations as would occur to one in the computer software art.

Text rendering application 200 includes program logic 204, which is responsible for carrying out some or all of the techniques described herein. Program logic 204 includes logic 206 for receiving a request from an application to display characters on an output/display device; logic 208, for converting the shapes of the characters from an original format, such as a vector format from a font, to an overscaled bitmap format; logic 210 for retrieving adjustable text contrast setting(s), such as a numeric or other value; and logic 212 for adjusting the width of the shapes of the characters based on the text contrast setting. Program logic 204 alternatively or additionally includes logic 214 for filtering to determine density values for how the shapes correspond to screen pixels; logic 216 for blending density values for shapes with color values related to the output device, such as foreground and/or background settings, and/or with a gamma correction setting related to the output device; logic 218 for displaying the characters in modified shapes on an output device; and other logic 220 for operating the application. In one implementation, program logic 204 is operable to be called programmatically from another program, such as using a single call to a procedure in program logic 204.

In one implementation, program logic 204 resides on computing device 100. However, it will be understood that program logic 204 can alternatively or additionally be embodied as computer-executable instructions on one or more computers and/or in different variations than shown on FIG. 2. Alternatively or additionally, one or more parts of text rendering application 200 can be part of system memory 104, on other computers and/or applications 115, or other such variations as would occur to one in the computer software art.

The examples presented herein illustrate using these technologies and techniques with a text rendering application in one implementation. However, as discussed previously, in other implementations these technologies and techniques are used with other systems for improving text rendering contrast.

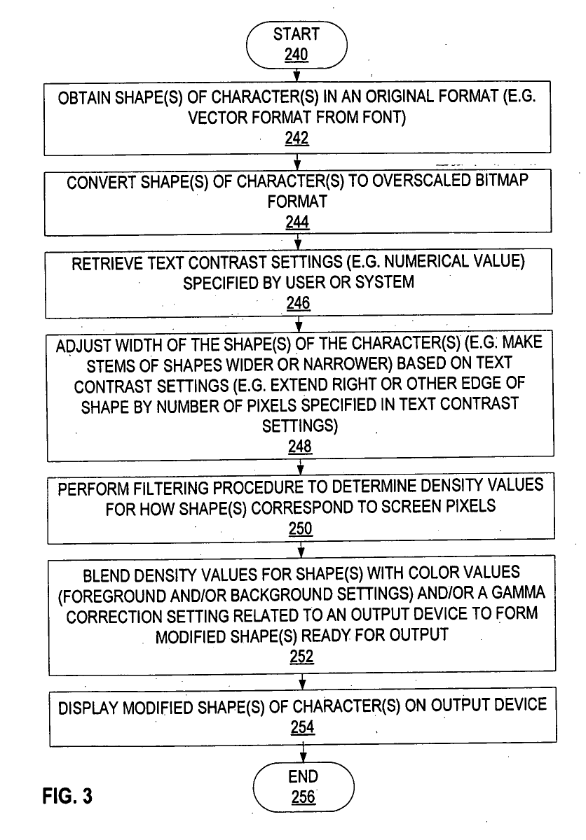

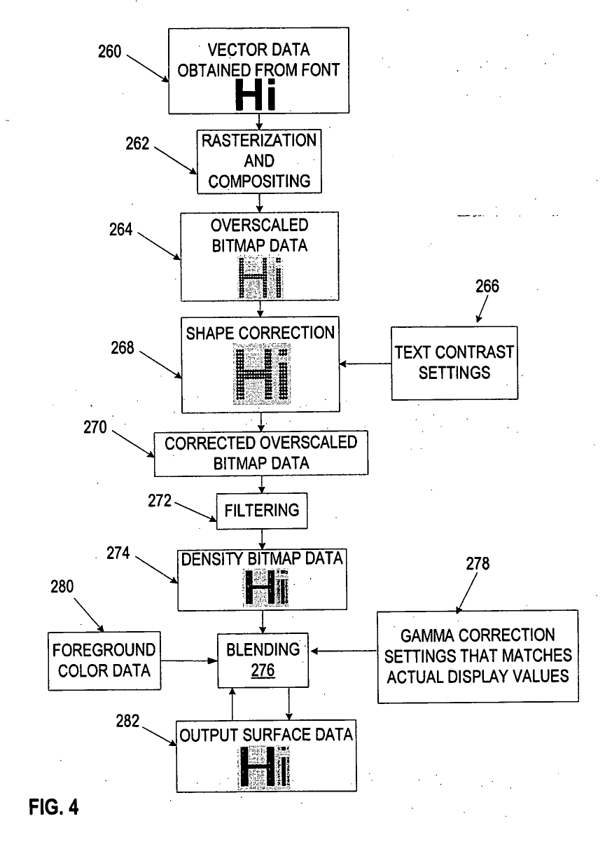

Turning now to FIGS. 3-4 with continued reference to FIGS. 1-2, the stages for implementing one or more implementations of text rendering application 200 are described in further detail. FIG. 3 is a high level process flow diagram for text rendering application 200. In one form, the process of FIG. 3 is at least partially implemented in the operating logic of computing device 100.

The procedure begins at start point 240 with obtaining the shapes of one or more characters in an original format, such as a vector format from a font (stage 242). The shapes of the characters are converted into an overscaled bitmap format (stage 244). The text contrast setting specified by the user or the system is retrieved (stage 246). In one implementation, the text contrast setting is a numerical value, such as a number ranging from zero to six. In another implementation, the text contrast setting is a value selected from a drop-down or other list in a user interface that is translated to a numeric value. In yet another implementation, the text contrast setting is a value specified in a settings file, such as one using an extensible markup language (XML) format. In a further implementation, the text contrast setting is a value specified by a developer in a specifications file to control the text contrast for one or more pieces of text in a particular application or document. One non-limiting example of such a specifications file includes a file written using an Extensible Application Markup Language (XAML) format. Numerous other values and ways for representing one or more text contrast settings could also be used.

The widths of the stems of one or more shapes are then adjusted based on the text contrast settings (stage 248). In one implementation, the stems of the shapes are made wider or narrower based on the value specified for the text contrast setting. As one non-limiting example, the right or other edge of the shape is extended by a number of pixels that corresponds to the number specified in the text contrast setting.

A filtering procedure is performed to determine the density values for how the shape(s) correspond to screen pixels (stage 250). The density values for the shape(s) are blended with color values and/or a gamma correction setting that are related to an output device to form a modified shape ready for display on the output device (stage 252). One non-limiting example of the color values that can be used includes foreground and/or background color settings. The modified shape(s) of the characters are then displayed on the output device (stage 254). The process ends at point 256.

FIG. 4 illustrates one implementation of a more detailed process for improving text rendering contrast. In one form, the process of FIG. 4 is at least partially implemented in the operating logic of computing device 100. The procedure begins with vector data being obtained from the font (stage 260). Rasterization and compositing are performed (stage 262) to generate the overscaled bitmap data (stage 264). Using the text contrast setting (stage 266), the shapes of the characters are adjusted (stage 268). This adjustment produces corrected overscaled bitmap data (stage 270). A filtering procedure is then performed (stage 272) to determine the density values for how the shapes correspond to screen pixels (stage 274). The density values are blended with color values and/or a gamma correction setting that are related to an output device (stage 276). A gamma correction setting that matches the actual display values is used in the blending process (stage 278), as well as foreground color data (stage 280). The output surface data is then generated (stage 282) in a format that is ready for display on an output device.

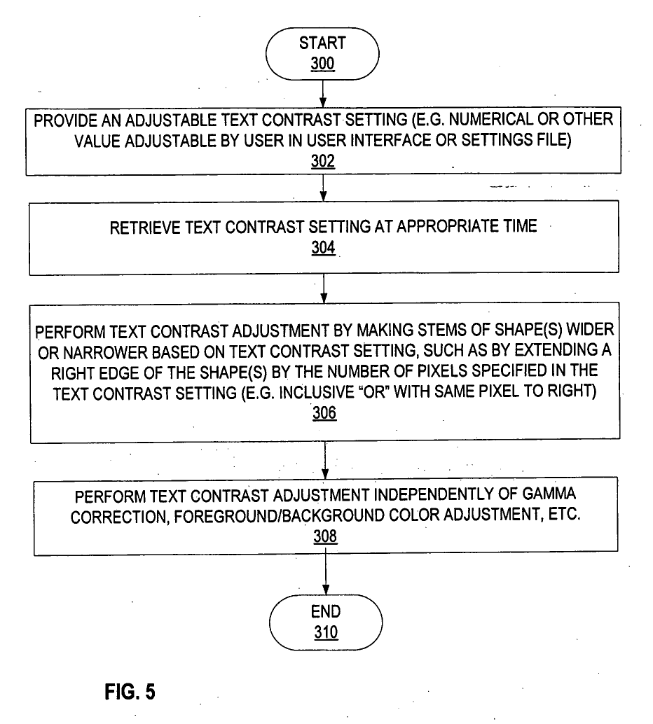

FIG. 5 illustrates the more detailed stages involved in adjusting text rendering contrast. In one form, the process of FIG. 5 is at least partially implemented in the operating logic of computing device 100. The process begins at start point 300 with providing an adjustable text contrast setting (stage 302). In one implementation, the text contrast setting is a numerical or other value, such as one adjustable by a user in a user interface or settings file. The text contrast setting is retrieved at the appropriate time (stage 304), such as when text rendering application 200 receives a request to display characters on an output device. The text contrast adjustment procedure is performed to make the shape(s) wider or narrower based on the text contrast settings (stage 306). In one implementation, the right or other edge of the shape is extended by the number of pixels specified in the text contrast setting. In programmatic terms, this can involve performing an inclusive “OR” with the same pixel to the right, or other similar variations for widening or narrowing the shape of the character. The text contrast adjustment is performed independently of gamma correction, foreground and/or background color adjustments, etc. (stage 308). The process then ends at end point 310.

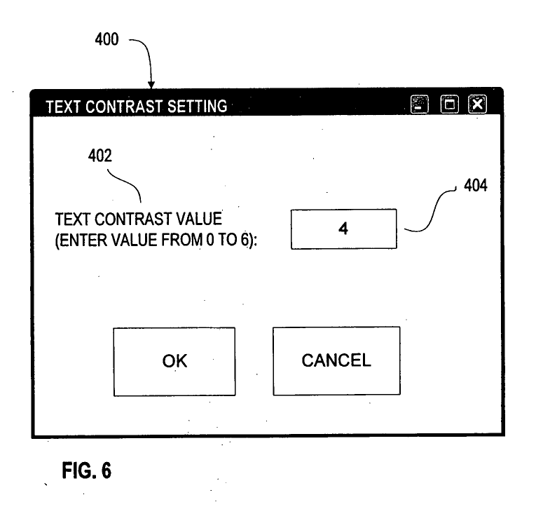

Turning now to FIG. 6, a simulated screen 400 is shown to illustrate a user interface that allows a user to adjust the text contrast setting used by text rendering application 200. This screen can be displayed to users on output device(s) 111. Furthermore, this screen can receive input from users from input device(s) 112. The text contrast setting explanation is shown 402, to indicate that the user can specify a numeric value in a particular range, which in this non-limiting example can range from “0” to “6”. The numeric value is then specified in input field 404, such as the value “4” shown. Numerous other variations could also be used for allowing a user or the system to specify a text contrast setting. These variations can include other types of user interfaces, settings files, and/or any other manner for allowing a user or the system to specify a text contrast setting.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for improving text rendering contrast comprising the steps of:
obtaining a shape of at least one character in a vector format;
converting the shape of the at least one character to a bitmap format, wherein the shape of the character is overscaled in the bitmap format;
adjusting a width of the shape of the character based on a text contrast setting;
performing a filtering procedure to determine a set of density values for how the shape corresponds to a set of screen pixels; and
blending the set of density values for the shape with a set of color values related to a display device to form a modified shape ready for output.

2. The method of claim 1, further comprising:
displaying the modified shape of the character on the display device.

3. The method of claim 2, wherein the blending step further comprises using a gamma correction setting that corresponds to actual display features of the display device.

4. The method of claim 1, wherein the text contrast setting is specified by a user.

5. The method of claim 1, wherein the text contrast setting is a numerical value.

6. The method of claim 1, wherein the adjusting step further comprises extending an edge of the shape by a number of pixels corresponding to a numerical value associated with the text contrast setting.

7. The method of claim 1, wherein the adjusting step further comprises making the shape of the character wider.

8. The method of claim 1, wherein the adjusting step further comprises making the shape of the character thinner.

9. The method of claim 1, wherein the vector format is obtained from a font associated with the character.

10. A computer-readable medium having computer-executable instructions for causing a computer to perform the steps recited in claim 1.

11. A computer-readable medium having computer-executable instructions for causing a computer to perform steps comprising:
provide a text contrast setting that is adjustable; and
upon receiving a request from an application to display at least one character on a display device, performing a set of steps comprising:
converting a shape of at least one character from an original format to a bitmap format, wherein the shape of the character is overscaled in the bitmap format;
retrieving the text contrast setting;
adjusting a width of the shape of the character based on the retrieved text contrast setting;
performing a filtering procedure to determine a set of density values for how the shape corresponds to a set of screen pixels;
blending the set of density values for the shape with a set of color values related to the display device to form a modified shape ready for output; and
displaying the modified shape of the character on the display device.

12. The computer-readable medium of claim 11, wherein the adjusting step further comprises extending an edge of the shape by a number of pixels corresponding to a numerical value associated with the text contrast setting.

13. The computer-readable medium of claim 11, wherein the blending step further comprises using a gamma correction setting that corresponds to actual display features of the display device.

14. The computer-readable medium of claim 11, wherein the original format is a vector format retrieved from a font.

15. The computer-readable medium of claim 11, wherein the text contrast setting is stored in a settings file.

16. The computer-readable medium of claim 11, wherein the text contrast setting is provided in a manner that is adjustable by a user.

17. A method for improving text rendering contrast comprising the steps of:
converting a shape of at least one character from an original format to a bitmap format, wherein the shape of the character is overscaled in the bitmap format;
adjusting a width of the shape of the character based on a text contrast setting, wherein the width is adjusted by extending an edge of the shape by a number of pixels corresponding to a numerical value associated with a text contrast setting;
performing a filtering procedure to determine a set of density values for how the shape corresponds to a set of screen pixels; and
blending the set of density values for the shape with a set of color values related to the display device to form a modified shape ready for output.

18. The method of claim 17, wherein the blending step uses a gamma correction setting and wherein a text contrast adjustment is achieved for the shape independently of the gamma correction setting.

19. The method of claim 17, wherein the set of color values include foreground color values.

20. A computer-readable medium having computer-executable instructions for causing a computer to perform the steps recited in claim 17.
